(19) United States
(12) Patent Application Publication
(10) Pub. No.: US 2007/0170196 A1
(43) Pub. Date: Jul. 26, 2007

(54) Package for storing and dispensing foil protected edible film strips

(75) Inventors: Agjah I. Libohova, E. Setauket, NY (US); David E. Mroczka, Westbury, NY (US); Anthony Orchard, Westbury, NY (US)

Correspondence Address: OSTROLENK FABER GERB & SOFFEN, 1180 AVENUE OF THE AMERICAS, NEW YORK, NY, 100368403, US

(73) Assignee: Autronic Plastics, Inc.

(21) Appl. No.: 11/639,668

(22) Filed: Dec. 15, 2006

Related U.S. Application Data
(60) Provisional application No. 60/750,911, filed on Dec. 15, 2005.

(51) Int. Cl. G07F 11/72

(52) U.S. Cl. 221/30

(57) ABSTRACT

A package for storing and dispensing edible film strips in accordance with an embodiment of the present invention includes a base, a top connected to the base such that the base and top are open at one end, a cover operable to rotate between a closed position in which the open end of the base and top is covered and an open position wherein the open end of the base and top remains open; and at least one pouch, including an edible film strip, positioned in the base and top such that at least a portion of the pouch is exposed when the cover is in the open position. The pouch preferably includes a base section, a top section attached to the base section such that the base section and top section are sealed to each other along a respective periphery thereof to form a water proof area in the center, in which the edible film strip is stored, an attachment section operable to detachably attache the medicinal pouch to a storage package and a tab connected to the top section of the pouch that is operable to separate the top section from the base section along the seal when pulled by a user to expose the dosage of medicine in the center section.

### CROSS REFERENCE TO RELATED APPLICATIONS

This application claims the benefit of and priority to U.S. Provisional Patent Application Ser. No. 60/750,911 entitled PACKAGE FOR DISPENSING STORAGE FOIL PROTECTED QUICK DISSOLVE EDIBLE FILM STRIPS filed Dec. 15, 2005, the entire contents of which are hereby incorporated by reference herein.

### BACKGROUND OF THE INVENTION

1. Field of the Invention

The present invention relates to a package for dispensing a plurality of protective pouches, each of which contains an edible film strip with a dose of a medication, supplement or other substance embedded therein. More specifically, the present application relates to a package for storing and dispensing a plurality of foil packages, each of which contains an edible filmstrip.

2. Related Art

A new technique in drug delivery is the use of edible film strips, which provide a very convenient means of taking medications, supplements, or other substance such as breath fresheners, for example. The edible film strip typically includes an active ingredient or drug, and offers a fast-dissolve oral delivery platform that is pleasant to the taste and experience.

There currently is no commercial package in the marketplace that is capable of safely and easily delivering unit dose quick dissolve edible film strips (medicated or otherwise) enclosed in individual foil pouches. The current state of the art package is based on individual foil pouches that are difficult to open and thus child resistant. While this package succeeds in protecting the film strips from environmental exposure including water vapor, oxygen, light and other detrimental agents, and also creates a level of child resistance for public safety, the existing single pouches are an impediment to practical use by adults that find the package too difficult to open.

Thus, it would be advantageous to provide a package for storing and dispensing a plurality of foil pouches holding individual edible film strips that avoids the problems discussed above.

### SUMMARY OF THE INVENTION

It is an object of the present invention to provide a package for storing and dispensing edible film strips that avoids the problems described above.

A package for storing and dispensing edible film strips in accordance with an embodiment of the present invention includes a base, a top connected to the base such that the base and top are open at one end, a cover operable to rotate between a closed position in which the open end of the base and top is covered and an open position wherein the open end of the base and top remains open and at least one pouch, including the edible film strip, positioned in the base and top such that at least a portion of the pouch is exposed when the cover is in the open position.

A package for storing and dispensing edible film strips in accordance with another embodiment of the present invention includes a base having a top, a bottom and a sidewall extending between the top and bottom around a periphery of the base such that at least one end of the base is open and a tray with a recess formed in a center thereof in which a plurality of pouches including the edible film strips are stored, wherein the tray is configured to slide in and out of the open end of the base to cover and expose the pouches.

A pouch for storing an edible film strip in accordance with an embodiment of the present invention includes a base section, a top section attached to the base section such that the base section and top section are sealed to each other along a respective periphery thereof to form a water proof area in the center, in which the edible film strip is stored, an attachment section operable for detachable attachment to the package and a tab connected to the top section of the pouch and that is operable to separate the top section from the base section along the seal when pulled by a user to expose the edible film strip in the center section.

Other features and advantages of the present invention will become apparent from the following description of the invention which refers to the accompanying drawings.

### BRIEF DESCRIPTION OF THE DRAWING(S)

FIG. 1 illustrates a package for storing and dispensing a plurality of protective pouches according to an embodiment of the present invention;

FIG. 2 illustrates a base and a top of the package of FIG. 1;

FIG. 3 illustrates the package of claim 1 with a cover thereof in a closed position;

FIG. 4 illustrates a protective pouch containing an edible film strip of the type stored in the package of FIG. 1;

FIG. 5 illustrates a top section of the pouch of FIG. 4 being separated from the base section of the pouch of FIG. 4;

FIG. 6 illustrates the pouch of FIG. 4 with the edible film strip completely exposed;

FIG. 7 illustrates the pouch of FIG. 4 separated from an attachment section of the pouch;

FIG. 8 illustrates a perspective view of a package for storing and dispensing a plurality of protective pouches according to another embodiment of the present invention;

FIG. 9 illustrates a top view of the package of FIG. 8 in a closed configuration.

FIG. 10 illustrates a top view of the package of FIG. 8 is an open configuration; and

FIG. 11 illustrates a side view of the package of FIG. 8 in an open configuration.

### DETAILED DESCRIPTION OF PREFERRED EMBODIMENTS OF THE INVENTION

The present invention provides a package 10 for dispensing a plurality of protective pouches 12, each of which stores an edible film strip 28. Each of the edible film strips 28 preferably provides an individual dose of a medication, supplement or other substance, and a single edible film strip is preferably stored in each of the plurality of protective pouches 12. The pouches 12 are easy to access by adults after an initial child resistant lock on the package 10 is unlocked. This is accomplished by providing the child resistance feature(s) on the outer package 10 only and by providing an improved pouch geometry for the plurality of pouches 12 inside of the outer package. The improvement of the internal pouches 12 allows the user to remove a single edible film strip 28 with a single dose by pulling a tab 24 on the pouch 12 and tearing the pouch open.

The pouch 12 is designed such that when force is applied to the tab 24, the pouch starts to tear, revealing the dose, edible film strip 28. As tearing is completed, a slightly greater force then causes the pouch 12 to separate from the outer package 10. The torn section of the pouch 12 exposes, but still retains the dose, film strip 28. This allows the user to place the pouch 12 to his mouth to transfer the dose, film strip 28, without touching and contaminating the dose.

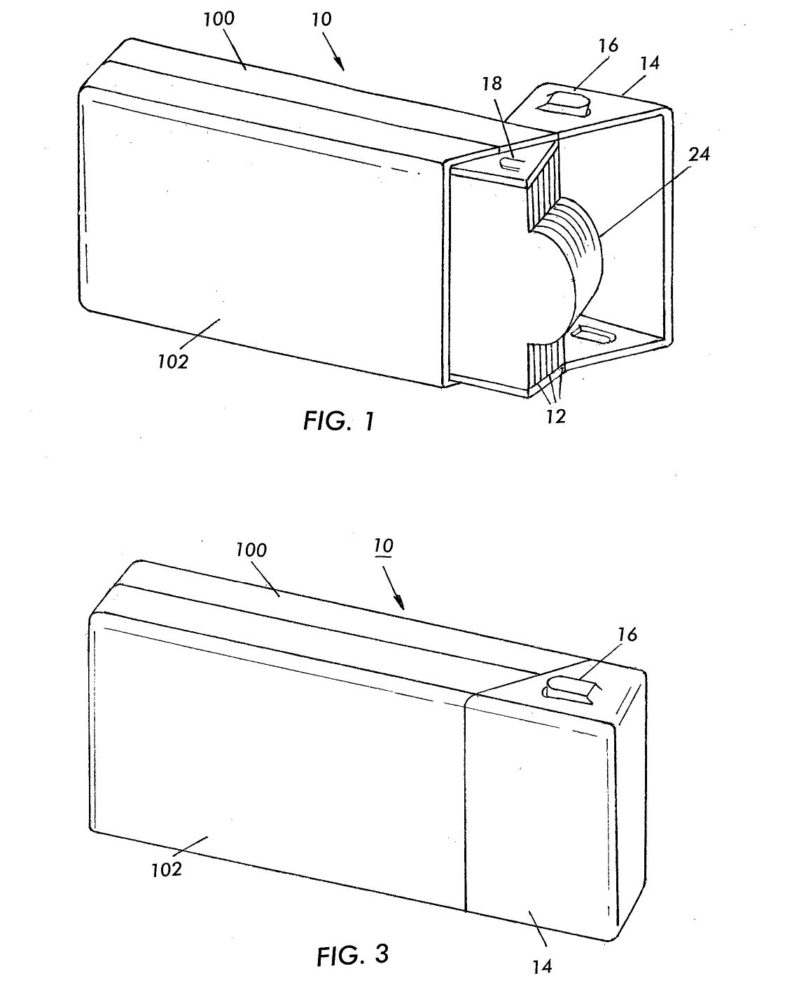

A package 10 for dispensing a plurality of protective pouches 12 is described in further detail with reference to FIGS. 1-3. As can be seen in FIG. 1, the package 10 preferably is capable of storing a plurality of pouches 12 safely. The package 10 is preferable rectangular in shape and open on one end to allow access the plurality of pouches 12. A cover 14 is preferably provided on the open end of the package 10 to allow the open end to be covered when not in use. First child proofing means 16 may be provided on the cover 14 and second child proofing means 18 may be provided on the package 10 to interact with the first child proofing means 16 on the cover to prevent a child from easily opening the package 10.

In FIG. 1, a depression (not shown) is formed in the inner surface of the cover 14, and a bulge or button 16 is formed on the outside of the cover 14 corresponding to the depression. The depression cooperates with a post 18 extending from the package 10 to provide the child proofing. More specifically, the post 18 may extend from a section of the sidewall 104a, 104b, that is space slightly inward, such that when the cover 14 is closed the post 18 is positioned in the depression. In order to open the cover 14, a user simply presses on the button 16, which pushes the post 18 inward to free the cover 14 to open. While the present application specifically describes child proofing using the depression, button 16 and post 18, it is noted that the present application is not limited to such child protection and any means for providing child protection may be used.

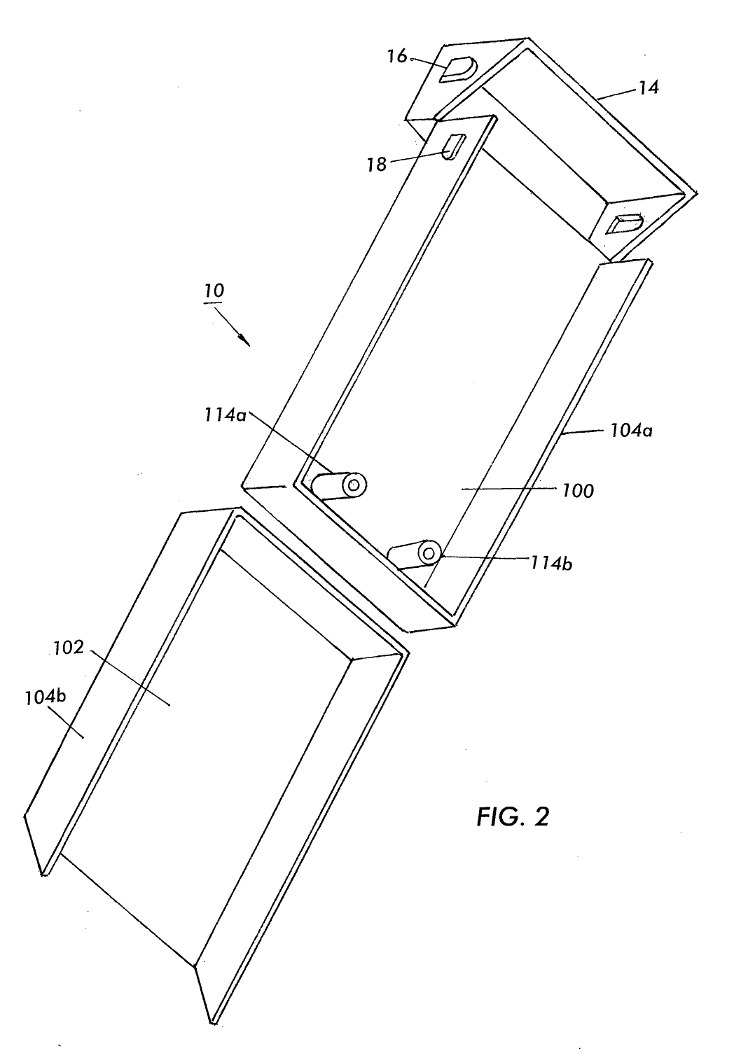

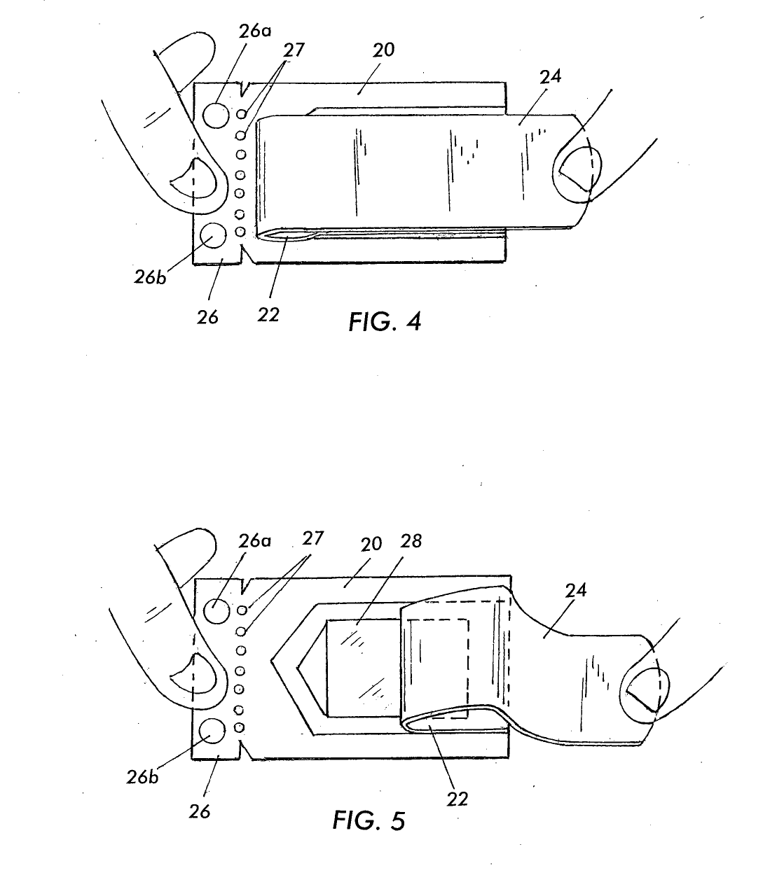

The package 10 preferably includes a base 100 with a sidewall 104a and a top 102, with a sidewall 104b which are connected to each other on at least three sides via the sidewalls 104a, 104b (see FIG. 2). As noted above, one end of the package 10 is preferably left open, and cover 14 is provided to cover the open end. Preferably, the cover 14 is rotatably attached to one of the base 100 and top 102 to rotate between an open position (see FIG. 1) in which the pouches 12 are exposed and a closed position (see FIG. 3) in which the pouches are covered by cover 14. Attachment posts 114a, 114b (FIG. 2) preferable extend upward from the base 100, on an end of the package 10 opposite the open end, and pass through the attachment openings 26a, 25b (See FIG. 4, for example) of the pouches 12 to attach the pouches to the package 10. It is noted that the attachment posts 114a, 114b may also extend downward from the top 102, if desired. While the package 10 illustrated in FIGS. 1-3 of the present application is rectangular in shape, it is noted that the present application is not limited to this shape and that the package 10 may be most any shape, such as, a square or circular, for example.

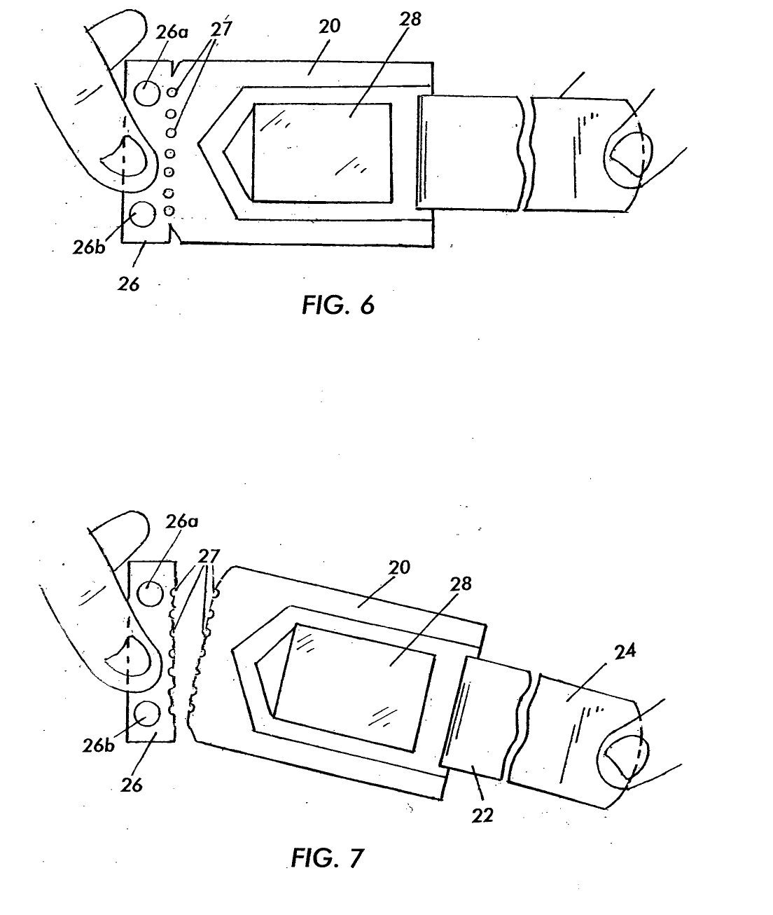

As noted above, each pouch 12 of the plurality of pouches stored in the package 10 preferably includes an edible film strip 28 (see FIGS. 5-6) that contains a single dose of a medication, supplement or other substance. The pouches 12 of the present application are described in further detail with reference to FIGS. 4-7. Each pouch 12 is preferably rectangular in shape and similar in size to the package 10, but slightly smaller, such that it fits within the package 10. Each pouch 12 includes a base section 20 and a top section 22. The base section 20 and top section 22 are typically made of a foil type substance, at least on an inner surface thereof. The base (or bottom) section 20 and top section 22 are preferably sealed together at their edges such that a substantially moisture free space is provided in a center of the pouch 12, in which the edible film strip 28 can be stored free from moisture. A tab 24 is preferably attached to a distal end, furthest from the user, of the top section 22 of the pouch 12. The tab 24 preferable extends forward along the length of the top section 22 and terminates at a point slightly beyond the proximal edge of base section 120 and top section 122 of the pouch 12. While the pouches 12, discussed above are illustrated as substantially rectangular in shape, it is noted that the present invention is not limited to this shape and that the pouches 12 may be most any shape, such as, a square or circular, for example.

An attachment section 26 is attached to the pouch 12 at a distal end thereof, beyond the distal edges of the base section 20 and the top section 22. The pouch 12, is attached to the package 10 via the attachment section 26. Preferably, attachment openings 26a, 25b are formed in the attachment section 26, through which attachment posts 114a, 114b of the package 10 pass to hold the pouch 12 in the package 10. The attachment section 26 is preferably detachably connected to the pouch 12, for example, via perforations 27 such that the pouch 12 can be easily detached from the package 10 if desired.

In operation, a user opens the cover 14 of the package 10 and the pouches 12 are exposed as illustrated in FIG. 1. In particular, the proximal ends of the tabs 24 of each of the pouches 12 are clearly visible since the tabs 24 extend slightly beyond the proximal ends of the top sections 22 and the base sections 20 of the pouches. The user then grasps one of the tabs 24 of one of the pouches 12, preferably the top-most pouch 12 (see FIG. 4). The user pulls the tab 24 outward, in a direction toward the user, to pull the top section 22 of the pouch 12 away from the base section 20 to partially expose the edible film strip 28 (see FIG. 5). Since the pouch 12 is secured to the package 10 via the attachment section 26, when the user applies pressure on the tab 24, the top section 22 separates from the base section 20, but the pouch 12 stays within the package 10. If desired, seams may be formed in the top section 22 of the pouch 22 to ensure that the top section 22 easily separates from the bottom section 20. In addition, since the base and top sections 20, 22 are sealed to each other around their edges, little pressure in necessary to pull the top section 22 away from the base section 20 if applied more towards the center of the top section 22, away from any of the edges. Thus, the tab 24 is preferably attached to the top section 22 on the top surface thereof, at a point removed slightly from the distal edge of the top section 22.

Once the top section 22 has been pulled away from the base section 20 far enough to completely expose the edible film strip 28 (see FIG. 6), the top section 22 is only attached to the bottom section 20 at a proximal edge thereof. At this point, any additional pressure applied to the tab 24 will result in the pouch 12, more specifically, base section 20 and top section 22, detaching from the attachment section 26 (See FIG. 7). Such detachment may take place at the perforations 27, for example. This occurs because the bond between the top section 22 and the base section 20 of the pouch 12 at the proximal edge thereof, is stronger than the detachable connection between the attachment section 26 and the pouch 12, for example, along perforations 27.

Since the pouch 12, with the edible film strip 28 still positioned on it, is thus detachable from the package 10, the user can then remove the pouch 12 and the edible film strip 28 from the package 10 and insert the edible film strip directly into the user's mouth, without risking contamination by touching it with his or her fingers. Naturally, the user may simply remove the edible film strip with his or her fingers if contamination is not an issue, for example.

Alternatively, after the top section 22 of the pouch 12 has been pulled away from the base section 20 to partially expose the edible film strip 28 as illustrated in FIG. 5, the top section 22 may stop pulling away from the base section 20. In this manner the top section 22 will keep the partially exposed film strip 28 in the pouch 12. In this case, when additional pressure is applied to the tab 24, since the top section 22 no longer separates from the base section 20, the additional pressure will separate the pouch 12, more specifically, base section 20 and top section 22, from the attachment section 26 along the perforations 27, for example. In this embodiment, the top section 22 is sealed to the base section 20 such that the seal between the top section 22 and base section 20 at the point where the edible film strip 28 is exposed is stronger than the connection between the attachment section 26 and the pouch 12. Thus, in this embodiment, the top section 22 keeps the edible film strip 28 in place even after the pouch 12 is detached from the attachment section 26.

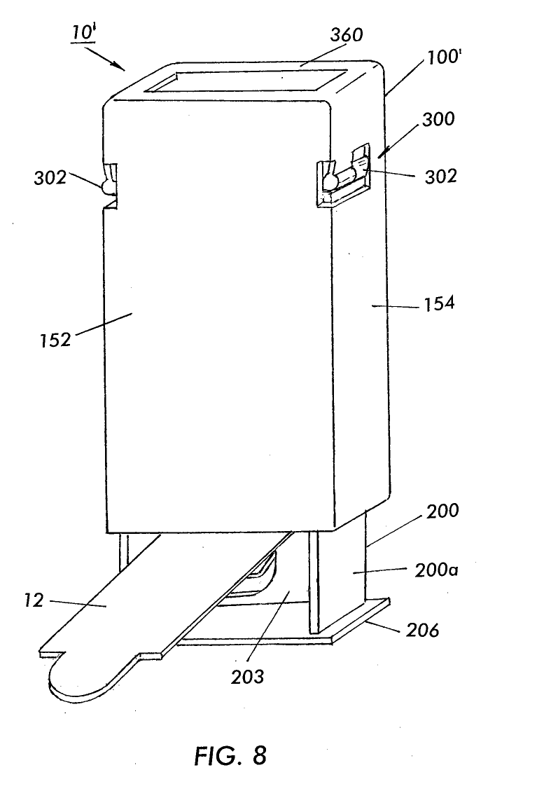

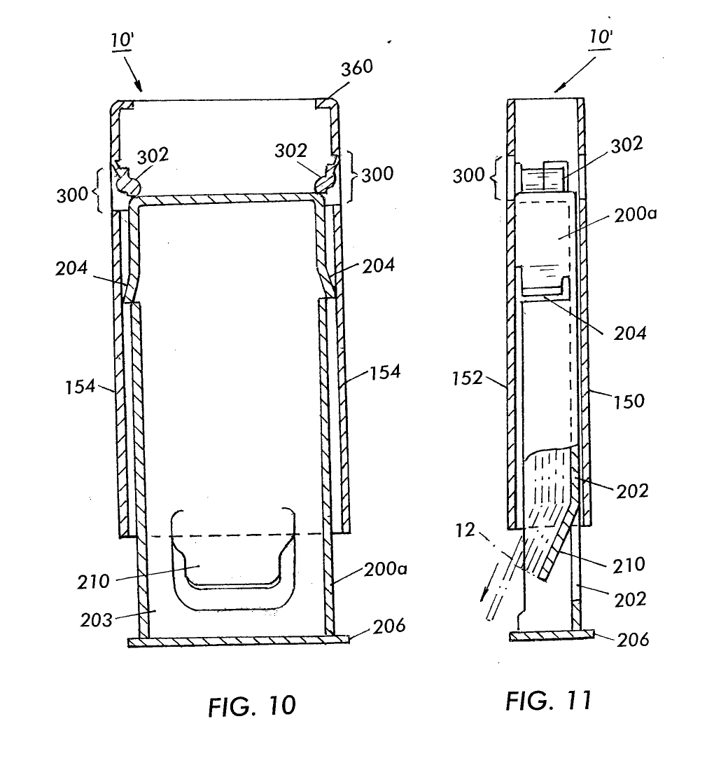

An alternate embodiment of a package 10′ in accordance with the present invention is described with reference to FIGS. 8-11. The package 10′ is similar to the package 10 of FIG. 1 in that that it includes a base 100′ that is substantially rectangular in shape and is open on at least one end. The base 100′ preferably includes a bottom 150 (See FIG. 11), a top 152 and a sidewall 154 extending between the bottom 150 and the top 152 such that at least one end of the base 100′ is open. However, the package 10′ of FIG. 8 includes a tray 200 which is slidable into the base 100′ through the open end. As illustrated in FIG. 8, both ends of base 100′ may be opened with a base flange 360 extended into an opening on the side into which the tray 200 does not slide into the base. This flange 360 cooperates with an end of the tray 200 to close that end of the base 100′. The tray 200 includes a bottom 202 (see FIG. 11, for example) and sidewalls 200a extending upward from a top surface of the bottom around a periphery of the bottom such that there is a recess 203 formed in the tray 200. Preferably, the pouches 12 described above are stored in this recess 203 in the tray 200. The tray 200 is sized such that it is slightly smaller than the base 100′, thus allowing the tray to slide within the base 100′. When the tray 200 slides all the way into the base 100′ the sidewall 200a of the base acts to close off the open end, that is, the end into which the tray slides, of the base 100′ such that the pouches 12 are secured inside the base 100′. The sidewall 200a of the tray may include a tray flange 206 that extends slightly outward to ensure that the end of the base 100′ is covered when the tray 200 is slid all the way into the base 100′. The tray 200 is slidable out of the base 100′ to expose the pouches 12. In a preferred embodiment, the tray 200 slides out of the base 100′ only partially so that at least the tabs 24 of the pouches 12 are exposed. A stop (not shown) may be provided on the inner surface of the sidewall 154 of base 100′ to interact with the tab 204 of the tray 200 to limit the amount that the tray slides out of the base even in the open position. The tray 200 preferably also includes attachment posts 114a′, 114b′ (not shown) similar to those described above to the secure the pouches 12 to the tray 200 in substantially the same manner as the pouches are secured to the package 10 described above. However, any other suitable means for attaching the pouches 12 to the tray 200 may be used.

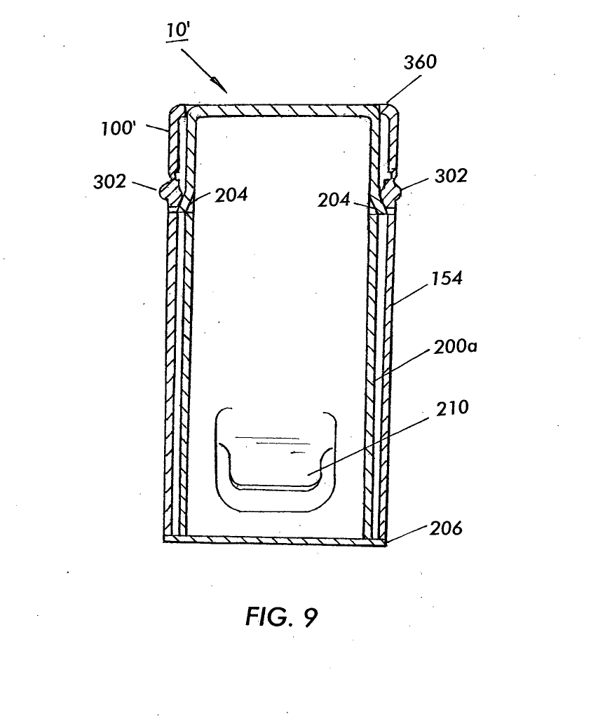

The package 10′ also includes child safety features. In this embodiment the sidewalls 200a of the tray 200 include at least one tab 204 (see FIGS. 9-11) that extends slightly outward from an opening the sidewall 200a. A corresponding opening 300 is formed in a sidewall 150 of the base 100′. When the tray 200 is all the way in the base 100′, the tab 204 extends outward into the opening 300 in the sidewall 150 of the base 100′ and prevents the tray 200 from sliding out. A locking release tab 302, or tabs, extends into the opening 300 in the sidewall 150 of the base 100′ and is resiliently flexible such that by pressing inward on the locking release tab 302 the tab 204 of the tray 200 is pushed inward and out of the opening 300 in the sidewall 150 of the base 100′ such that the tray is free to slide out of the base. Thus, the package 10′ can be secured in the closed position until sufficient force is applied to the release tabs 302. Thereafter, the tray 200 can be slid out of the base 100′ to expose the pouches 12. In a preferred embodiment, the pouches 12 are removed from package 10′ in substantially the same manner as described above. That is, the user preferably grasps the tab 24 and pulls to separate the top and bottom section of the pouch 12 and to expose the film. If the user continues to pull the pouch 12 separates from the tray 200. The tray 200 may include a positioning tab 210 (See FIGS. 9-11) that extends resiliently upward from the bottom thereof to hold the pouches 12 slightly upward relative to the bottom of the tray 200 to make it easier to access them. This tab 210 may be integral with and form a part of the tray 200 or may be added to a top surface of the tray.

It is also noted within the industry that when a pouch is visibly opened it cannot be mistakenly assumed by a user that the dose is still protected by some child resistant feature. Since the invention causes the pouch 12 to open before it is separated from the outer package, it is of great benefit to consumer safety.

The packages 10 and 10′ of the present application thus provide means to safely and easily store and dispense a plurality of pouches 12 of edible film strips 28 while allowing easy access thereto when desired by simply opening a single child proof mechanism incorporated into the package 10, 10′. The pouches 12 are safely stored inside the package 10 until their use is desired and can easily be opened in conjunction with the package 10.

The packages 10, 10′ of the present application may hold any number of pouches 12, although in a preferred embodiment it is used to dispense and store 10 pouches 12. As described above, the pouches 12 remain sealed until they are ready to be used by the user. In addition, the package 10 provides child protection and complies with CPSC requirements (CFR 16 Part 1700) for a visibly opened package immediately prior to dispensing. In addition, the packages 10, 10′ are senior friendly, providing a simple means for opening the packages while still incorporating child protection features, thus encouraging patient compliance in taking medication and the like while still protecting children. The innovative design of the packages 10, 10′ and the pouches 12 is distinctive and easy to identify. Further, the general shape described herein is familiar to smokers or ex-smokers and thus easy for such user to recognize. Further, the packages 10, 10′ and pouches 12 of the present application provide for both safe and easy use at a low cost of manufacture.

While the packages 10, 10′ described herein has been described as dispensing and storing pouches 12 with edible film strips 28 it is noted that the pouches 12 may contain a variety of other items. For example, the pouches 12 may contain trans-dermal or trans-mucosal patches, that is patches, usually embedded with medication or another substance to be administered to a patient by exposure to the patient's skin or mucous membranes, respectively. Alternatively, the pouches 12 may be used to store medicated swabs. The pouches 12 may also contain bandages, either medicated or un-medicated. The pouches 12 may contain most any item where it is useful for the item to be protected from moisture and/or light, or to generally be protected from contamination. It is noted that the pouches need not include medicine at all, as is noted above, and may be used to deliver breath fresheners or herbal treatments as well.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A package for storing and dispensing edible film strips comprises:
a base,
a top, connected to the base such that the base and top are open at one end;
a cover operable to rotate between a closed position in which the open end of the base and top is covered and an open position wherein the open end of the base and top remains open; and
at least one pouch, including the edible film strip, positioned in the base and top such that at least a portion of the pouch is exposed when the cover is in the open position.

2. The package of claim 1, wherein the cover further comprises at least one depression formed on an inner surface of the cover; and
a button formed on an outside surface of the the cover, at a position corresponding to the depression on the inside cover.

3. The package of claim 2, wherein at least one of the base and top include a post that extends outward from a sidewall thereof and into the recess of the cover when the cover is in the closed position to secure the cover in the closed position.

4. The package of claim 3, wherein the post is pushed out of the recess when the button on the cover is pushed inward such that the cover is free to move into the open position.

5. The package of claim 4, wherein at least one of the base and the top include at least one securing post operable to secure the pouch in the package.

6. The package of claim 5, wherein the pouch further comprises:
a base section;
a top section attached to the base section such that the base section and top section are sealed to each other along a respective periphery thereof to form a water proof area in the center, in which the edible film strip is stored;
an attachment section operable for detachable attachment to the package; and
a tab connected to the top section of the pouch and that is operable to separate the top section from the base section along the seal when pulled by a user to expose the edible film strip in the center section.

7. The package of claim 6, wherein the attachment section further comprises:
at least one securing opening through which the securing post passes to secure the pouch in the package;
a perforated section provided between the attachment section and the base section and top section to allow for separation of the base section and top section from the attachment section.

8. The package of claim 7, wherein the tab is integral with the top section such that after the top section has been separated from the bottom section around the peripheral seal, when the user applies additional force in the same direction on the tab, the top section and bottom section separate from the attachment section along the perforation section such that they are easily removed from the package.

9. A package for storing and dispensing edible film strips comprises:
a base having a top, a bottom and a sidewall extending between the top and bottom around a periphery of the base such that at least one end of the base is open; and
a tray with a recess formed in a center thereof in which at least one pouch including an edible film strip is stored, wherein the tray is configured to slide in and out of the open end of the base to cover and expose the pouch.

10. The package of claim 9, wherein a sidewall of the tray includes a locking flange configured to extend outward from the sidewall of the tray.

11. The package of claim 10, wherein the sidewall of the base includes at least one locking opening into which the locking tab of the tray extends when the tray is all the way in the base, in a closed position, such that the tray is secured in the base.

12. The package of claim 11, wherein the sidewall of the base further includes a release tab extending into the opening in the sidewall of the base, wherein the release tab contacts the locking tab to push the locking tab out of the opening in the sidewall when force is exerted inward on the release tab to allow the tray to slide out of the base and to expose the pouch.

13. The package of claim 12, wherein the tray includes at least one securing post operable to secure the pouch in the package.

14. The package of claim 13, wherein the pouch further comprises:
a base section;
a top section attached to the base section such that the base section and top section are sealed to each other along a respective periphery thereof to form a water proof area in the center, in which an edible film strip is stored;
an attachment section operable for detachable attachment to the package; and
a tab connected to the top section of the pouch and that is operable to separate the top section from the base section along the seal when pulled by a user such that the edible film strip is exposed in the center section.

15. The package of claim 14, wherein the attachment section further comprises:
at least one securing opening through which the securing post passes to secure the medicinal pouch in the package;
a perforated section provided between the attachment section and the base section and top section to allow for separation of the base section and top section from the attachment section.

16. The package of claim 15, wherein the tab is integral with the top section such that after the top section has been separated from the bottom section around the seal, when the user applies additional force in the same direction on the tab, the top section and bottom section separate from the attachment section along the perforation section such that they are easily removed from the package.

17. A pouch for storing an edible film strip comprises:
a base section;
a top section attached to the base section such that the base section and top section are sealed to each other along a respective periphery thereof to form a water proof area in the center, in which the edible film strip is stored;
an attachment section operable for detachable attachment to the package; and
a tab connected to the top section of the pouch and that is operable to separate the top section from the base section along the seal when pulled by a user to expose the edible film strip in the center section.

18. The package of claim 17, wherein the attachment section further comprises:
at least one securing opening through which the securing post passes to secure the medicinal pouch in the package;
a perforated section provided between the attachment section and the base section and top section to allow for separation of the base section and top section from the attachment section.

19. The package of claim 18, wherein the tab is integral with the top section such that after the top section has been separated from the bottom section around the peripheral seal, when the user applies additional force in the same direction on the tab, the top section and bottom section separate from the attachment section along the perforation section such that they are easily removed from the package.

20. The medicinal pouch of claim 8, wherein the edible film strip includes a dosage of medicine.
